(19) United States
(12) Patent Application Publication
(10) Pub. No.: US 2026/0034803 A1
(43) Pub. Date: Feb. 5, 2026

(54) PRINTING APPARATUS FOR DIRECT TO GARMENT INKJET PRINTING THROUGH ROTARY MOTION

(71) Applicant: ELECTRONICS FOR IMAGING, INC., LONDONDERRY, NH (US)

(72) Inventors: Marco SERAFINI, Grassobbio (IT); Ernesto PROPERSI STERBIATI, Grassobbio (IT)

(21) Appl. No.: 19/106,849

(22) PCT Filed: Aug. 28, 2023
(86) PCT No.: PCT/US2023/031300

§ 371 Date: Feb. 26, 2025

Related U.S. Application Data
(60) Provisional application No. 63/374,352, filed on Sep. 1, 2022.

(51) Int. Cl. B41J 3/407; B41J 3/54; B41J 11/00; B41J 11/06; B41J 11/14; B41J 25/00

(52) U.S. Cl. CPC B41J 3/4078; B41J 3/543; B41J 11/002; B41J 11/06; B41J 11/14; B41J 25/003

(57) ABSTRACT

In a digital to garment printer having a rotary printing motion one or more T-shirt carriers are arranged on a fixed radius and rotate around a central column which houses one or more rotary tables. Each carrier is independent of the others but shares the same radius of rotation about the central column. All T-shirt carriers may share the same plane of rotation or be offset vertically and move to the printing plane with the up-down motion of the central column. On the same radius there are a series of fixed stations for printing as well as pretreatment, drying, and post treatment. The printing motion is achieved through the rotation of the T-shirt carrier that swipes under the print heads. The stepping motion can be achieved through the radial motion of the T-shirt carrier or the movement of the print head carrier.

### CROSS-REFERENCE TO RELATED APPLICATIONS

This application is a 371 national phase entry of Application No. PCT/US2023/031300 filed Aug. 28, 2023, which claims priority to U.S. Patent Application No. 63/374,352, filed Sep. 1, 2022, which is incorporated herein by reference in its entirety.

### FIELD

Various of the disclosed embodiments concern a method and apparatus for direct to garment printing comprising a rotary motion of the substrate with radially spaced print heads.

### BACKGROUND

Existing DTG (Direct to Garment) printers can be divided in two categories: analog printers and digital printers.

Analog DTG printers are mainly built on a circular base with multiple T-shirt carriers. The printer rotates about the center with a stop and go motion. A ring houses a set of printing stations that are displaced at precise angle intervals and at a fixed radius from the center of the printer. Each carrier is brought under an analog printing station where the relative color is applied. Subsequently, the entire center of the printer turns at a fixed angle to bring each carrier to the next printing station where another color is applied. The stationary printing stations and the rotating carriers are displaced on aligned angles, so that every rotation step brings all carriers into alignment with all stations. The fixed stations can comprise other functions, such as pretreatment of the garment, post treatment of the garment, and drying of the garment.

More recently, digital printing stations have been added to analog DTG printers by placing a print head carrier in place of an analog printing station and using the relative motion of the carrier to print on the garment with the T-shirt carrier stationary. This way, the printer can combine both digital and analog printing.

Digital DTG printers are not based on a circular motion, but rather on an orthogonal axis. One or more T-shirt carriers moves perpendicularly to one or more print head carriers. The relative motion between the two allows printing of a T-shirt with multiple passes. Usually, both carriers move while printing, where the printing motion is on the print head carrier, while the stepping motion is on the T-shirt carrier. Precise motion is achieved with linear motors or a system of belts.

### SUMMARY

The circular printer disclosed herein offers advantages in productivity and simplicity of design. Rotation is more efficient than linear motion and can be more precise. Faster movements translate into more productivity. The print heads could be stationary or have very little motion; dispensing the need for energy chains and long cables/tubes. Two or more T-shirt carriers can work independently allowing more than one station to work in parallel, thus further increasing productivity.

Embodiments of the invention comprise a digital DTG printer having a rotary printing motion. One or more T-shirt carriers are arranged on a fixed radius and rotate around a central column which houses one or more rotary tables. Each carrier is independent of the others but shares the same radius of rotation about the central column. All T-shirt carriers may share the same plane of rotation or be offset vertically and move to the printing plane with the up-down motion of the central column. On the same radius there are a series of fixed stations for printing as well as pretreatment, drying, and post treatment. The printing motion is achieved through the rotation of the T-shirt carrier that swipes under the print heads. The stepping motion can be achieved through the radial motion of the T-shirt carrier or the movement of the print head carrier.

### BRIEF DESCRIPTION OF THE DRAWINGS

FIG. 1 is a top-down view of an exemplary machine with two T-shirt carriers;

FIG. 2 shows a ¾ view of the same exemplary machine;

FIG. 3 shows a top-down view of a different embodiment with two orthogonal print head carriers; and

FIG. 4 shown an exemplary central rotary pillar having two garment carriers.

### DETAILED DESCRIPTION

The circular printer disclosed herein offers advantages in productivity and simplicity of design. Rotation is more efficient than linear motion and can be more precise. Faster movements translate into more productivity. In embodiments of the invention rotary motion is achieved with simpler mechanical means than linear motion. For example, an electric motor drives the rotation directly when mounted axially to the rotation shaft or geared at 90 degrees beside the shaft. In other embodiments a rotary table may be used to achieve higher precision without compromising speed and acceleration.

The print heads could be stationary or have very little motion; dispensing the need for energy chains and long cables/tubes. Two or more T-shirt carriers can work independently allowing more than one station to work in parallel, thus further increasing productivity.

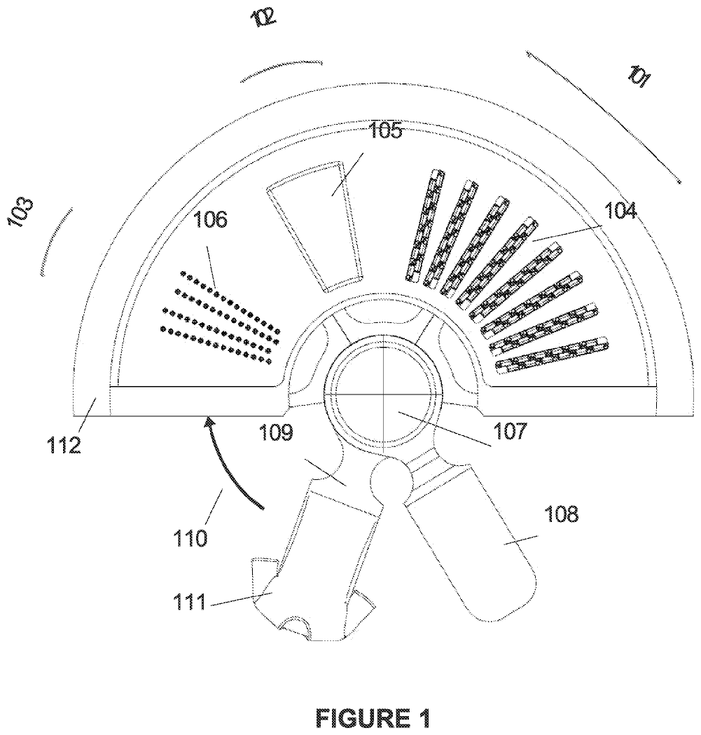

Various embodiments comprise a printing apparatus for direct to garment (DTG) inkjet printing through rotary motion. In the exemplary embodiment of FIG. 1 a series of printing and treatment stations 104, 105, 106 are arranged on a fixed radius. Inkjet print heads are arranged radially in station 104 along a predetermined angle 101 referred to hereafter as the printing angle. A set of sprinklers 106 are used for pretreating the garment along the pretreatment angle 103 and an auxiliary station 105, possibly housing a drying apparatus, is displaced along angle 102.

Software compensation is required to print radially. The print heads on the outer radius are further apart, in some embodiments, and the tangential speed of the garment is greater on the outer radius than the tangential speed on the inner radius. The limiting resolution of the process direction, i.e. the rotary axis, is the achievable frequency of the outer most print heads. The inner most print heads underperform to maintain a constant resolution along the radial direction. To achieve this, the sliced image, i.e. the image prepared by the slicing software, distorted along the radial direction to mimic in reverse the position of the print heads and the increasing tangential speed along the radial direction.

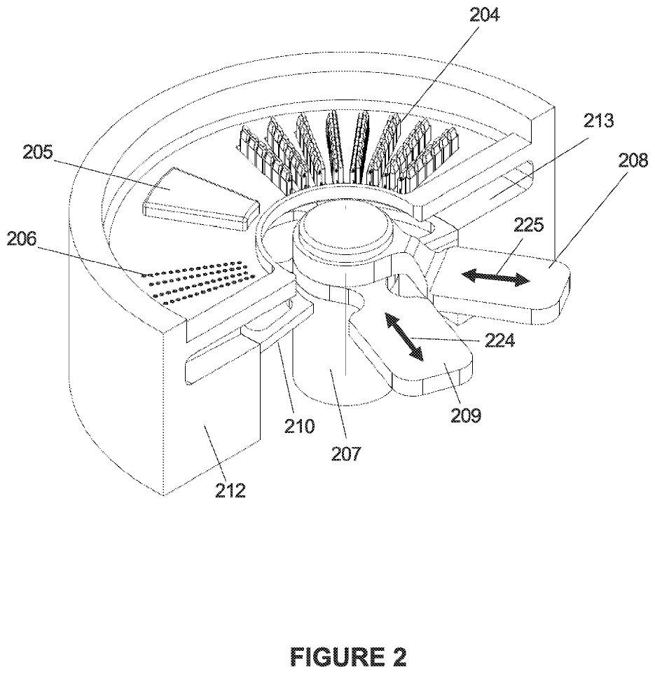

In the embodiment of FIG. 1, two T-shirt carriers 108, 109 hold the garment 111 with a mechanical system not shown that keeps the T-shirt flat and straight relative to the printer directions. The rotation 110 moves the T-shirt carriers 108, 109 around the central column 107 and under each station 104, 105, 106 through a slot 213 (see FIG. 2). Each station may be swiped by the carriers 108, 109 only once or multiple times, either to increase the quantity of treatment agent and ink deposition or to create a multi pass print. In this embodiment both T-shirt carriers are on the same plane, foregoing the need for a Z-axis movement on the central column 107. Those skilled in the art will appreciate that the T-shirt carriers may be placed in different planes. While two T-shirts carriers are shown in FIG. 1, those skilled in the art will appreciate that in embodiments of the invention any number of T-shirts carriers may be provided.

An additional axis 224, 225 (see FIG. 2) may be used to create a multi pass print by changing the radial distance of the garment between one pass and the next. In embodiments of the invention movement along axis 224, 225 can be achieved with conventional mechanical devices such as a linear slide, a worm screw motor, or a pneumatic piston. Consequently, in this embodiment both printing motion and stepping motion are located on carriers 208, 209. Printing motion is referred to as the axis of movement that drives the jetting of ink on the substrate. In this case it is the rotary direction 110. The stepping motion is referred to as the perpendicular motion to the printing motion. The two motions combined allow to print an image in more than one pass. In this embodiment, the print heads are stationary. The garment moves both axially (printing motion) and radially (stepping motion). As discussed above, a set of software corrections may be employed to print in this manner because the outer part of the image typically has a lower resolution than the inner part.

The main body of the printer 112, 212 may be round as depicted or square. The sum of all station's angles may be more than 180° depending on the necessary mechanical space. FIGS. 1-3 show a 180° spread of printing and treatment stations, but the overall angle occupied by these processes might be more than 180°, and less than 360°. The limiting factor is the space (angle) required by the human operator to load and unload the garment. This could be 90° and the printing and treatment stations could therefore occupy 270° of space. The central column 207 (see FIG. 2) may be rigidly attached to the printer body 212 by components 210. There are shafts for each carrier inside the central column that rotate within it.

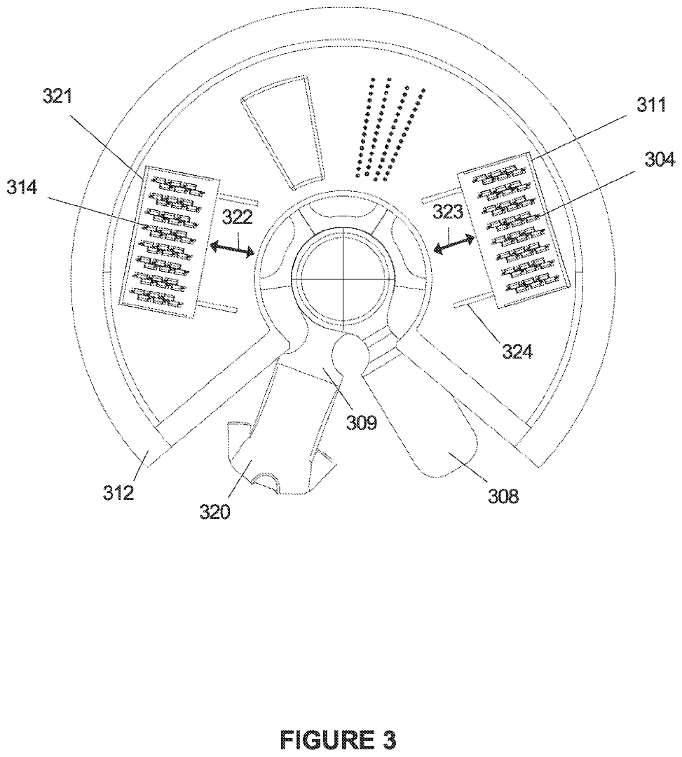

FIG. 3 shows a different embodiment where two separate printing stations 311, 321 are displaced on different angles. These stations may have an orthogonal array of print heads 304, 314, in a different manner than the previously radial array 104, 204. Furthermore, the stepping motion may be located on the print stations via axes 322, 323. Each print station may move on rails 324 or similar technology that allows to move the array of print heads radially. Unlike the embodiment of FIG. 2, in this embodiment the stepping motion, i.e. radial direction of motion, is performed by the print heads. A carriage 311, 321 moves along a set of rails in the direction of the central axis, thus placing the print heads on a smaller or bigger radius. This in turn is combined with the rotation of the garment carriage 308, 309, i.e. the printing motion, to print an image in more than one pass. This allows a simpler design of carriers 308, 309 and the possibility to print simultaneously on two T-shirts by using the independent motion of the carriers.

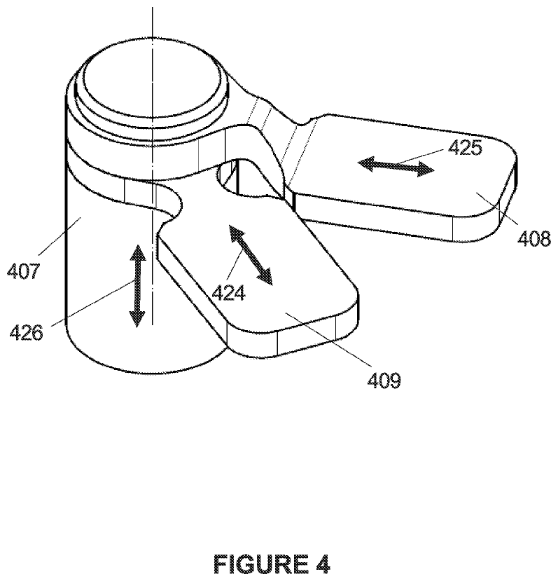

FIG. 4 shows an exemplary embodiment of the central column 407 with multiple auxiliary axes 424, 425, 426. Axes 424, 425 may be used to create the stepping motion for multi pass printing, while axis 426 can move one or both of the T-shirt carriers 408, 409 vertically. In embodiments of the invention vertical motion can be achieved with a pneumatic piston or a worm screw motor beneath column 407. This allows to use offset carriers on different planes, while still printing on a single plane.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A printing apparatus for direct to garment (DTG) inkjet printing, comprising:
a plurality of printing and treatment stations arranged on a fixed radius about a central column, wherein said central column defines a central printer axis;
a plurality of garment carriers, each garment carrier adapted to support a respective garment, wherein each of said garment carriers keeps a respective garment flat and straight relative to a printer direction; and
a rotary actuator for effecting axial printing motion by rotating said garment carriers and said respective garments around said central printer axis and under each said printing and treatment stations.

2. The printing apparatus of claim 1, said plurality of printing and treatment stations comprising a plurality of inkjet print heads arranged radially along a predetermined printing angle.

3. The printing apparatus of claim 1, said plurality of printing and treatment stations comprising a plurality of sprinklers for pretreating the garment along a pretreatment angle.

4. The printing apparatus of claim 1, said plurality of printing and treatment stations comprising an auxiliary station housing a drying apparatus displaced along a predetermined angle.

5. The printing apparatus of claim 1, wherein each station is swiped by the carriers one or more times, either to increase a quantity of treatment agent and ink deposition or to create a multi pass print.

6. The printing apparatus of claim 1, wherein said T-shirt carriers are on a same plane.

7. The printing apparatus of claim 1, wherein said T-shirt carriers are placed in different planes.

8. The printing apparatus of claim 1, further comprising:
an stepping axis for changing the radial distance of the garment carriers between one pass and the next to create a multi pass print.

9. The printing apparatus of claim 1, wherein both radial printing motion and axial stepping motion are effected by said garment carriers.

10. The printing apparatus of claim 1, further comprising:
at least two separate printing stations displaced on different angles.

11. The printing apparatus of claim 9, further comprising:
an orthogonal array of print heads.

12. The printing apparatus of claim 11, wherein a stepping motion is effected by said print stations via respective radial axes.

13. The printing apparatus of claim 12, further comprising:
one of more rails on which radial movement of each print station is effected to move each array of print heads radially.

14. The printing apparatus of claim 1, wherein independent motion of the plurality garment carriers effects simultaneous printing on a corresponding plurality of garments.

15. The printing apparatus of claim 1, said central column further comprising multiple auxiliary axes for creating stepping motion for multi pass printing.

16. The printing apparatus of claim 15, wherein at least one of said multiple auxiliary axes move one or more of said garment carriers vertically.

17. The printing apparatus of claim 16, further comprising:
a plurality of offset garment carriers positioned on different planes relative to each other;
wherein said vertical movement of said carriers positions each of said carriers for respective printing on a single plane.
